(19) United States
(12) Patent Application Publication
(10) Pub. No.: US 2025/0063000 A1
(43) Pub. Date: Feb. 20, 2025

(54) PROTOCOL DATA UNIT (PDU) SET DISCARD BASED ON PDU SET IMPORTANCE

(71) Applicant: QUALCOMM Incorporated, San Diego, CA (US)

(72) Inventor: Linhai HE, San Diego, CA (US)

(21) Appl. No.: 18/775,946

(22) Filed: Jul. 17, 2024

Related U.S. Application Data
(60) Provisional application No. 63/520,325, filed on Aug. 17, 2023.

(51) Int. Cl. H04L 47/32; H04L 47/11; H04W 28/06

(52) U.S. Cl. CPC H04L 47/32; H04L 47/11; H04W 28/06

(57) ABSTRACT

Various aspects of the present disclosure generally relate to wireless communication. In some aspects, a user equipment (UE) may receive a configuration of a criterion for discarding protocol data units (PDUs) associated with one or more PDU sets. The UE may receive or identify an indication of a congestion condition. The UE may discard one or more PDUs of a PDU set according to a PDU set importance (PSI) parameter of the PDU set, wherein the discard is based at least in part on the criterion. Numerous other aspects are described.

### CROSS-REFERENCE TO RELATED APPLICATION

This patent application claims priority to U.S. Provisional Patent Application No. 63/520,325, filed on Aug. 17, 2023, entitled “PROTOCOL DATA UNIT (PDU) SET DISCARD BASED ON PDU SET IMPORTANCE,” and assigned to the assignee hereof. The disclosure of the prior application is considered part of and is incorporated by reference into this patent application.

### FIELD OF THE DISCLOSURE

Aspects of the present disclosure generally relate to wireless communication and to techniques and apparatuses for protocol data unit (PDU) set discard based on PDU set importance.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

In some aspects, a method of wireless communication performed by a user equipment (UE) includes receiving a configuration of a criterion for discarding protocol data units (PDUs) associated with one or more PDU sets; receiving or identifying an indication of a congestion condition; and discarding one or more PDUs of a PDU set according to a PDU set importance (PSI) parameter of the PDU set, wherein the discard is based at least in part on the criterion.

In some aspects, an apparatus for wireless communication at a UE includes one or more memories; and one or more processors, coupled to the one or more memories, configured to cause the UE to: receive a configuration of a criterion for discarding PDUs associated with one or more PDU sets; receive or identify an indication of a congestion condition; and discard one or more PDUs of a PDU set according to a PSI parameter of the PDU set, wherein the discard is based at least in part on the criterion.

In some aspects, a non-transitory computer-readable medium storing a set of instructions for wireless communication includes one or more instructions that, when executed by one or more processors of a UE, cause the UE to: receive a configuration of a criterion for discarding PDUs associated with one or more PDU sets; receive or identify an indication of a congestion condition; and discard one or more PDUs of a PDU set according to a PSI parameter of the PDU set, wherein the discard is based at least in part on the criterion.

In some aspects, an apparatus for wireless communication includes means for receiving a configuration of a criterion for discarding PDUs associated with one or more PDU sets; means for receiving or identifying an indication of a congestion condition; and means for discarding one or more PDUs of a PDU set according to a PSI parameter of the PDU set, wherein the discard is based at least in part on the criterion.

Aspects generally include a method, apparatus, system, computer program product, non-transitory computer-readable medium, user equipment, base station, network entity, network node, wireless communication device, and/or processing system as substantially described herein with reference to and as illustrated by the drawings.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a network node in communication with a user equipment (UE) in a wireless network, in accordance with the present disclosure.

FIG. 3 is a diagram illustrating an example disaggregated base station architecture, in accordance with the present disclosure.

FIG. 4 is a diagram illustrating an example of signaling associated with discarding protocol data units (PDUs) associated with a PDU set importance (PSI) parameter, in accordance with the present disclosure.

FIG. 5 is a diagram illustrating an example process performed, for example, at a UE or an apparatus of a UE, in accordance with the present disclosure.

FIG. 6 is a diagram of an example apparatus for wireless communication, in accordance with the present disclosure.

### DETAILED DESCRIPTION

An application at a transmitter may generate information for consumption by an application at a receiver. For example, the information may include a unit of information that would benefit from being delivered to the receiver as an integrated unit after migrating through the transmitter's and receiver's network layers and radio access network (RAN) layers. To facilitate the delivery of a unit of information as an integrated unit (e.g., as opposed to handling different parts of the information independently and without consideration of the unit of information as a whole), a wireless communication technology (e.g., 5G/NR) may provide for protocol data units (PDUs) carrying the unit of information to be delivered as a PDU set. A PDU set may have common quality of service (QOS) attributes, such as a PDU set delay budget (PSDB) and a PDU set error rate (PSER). A PDU set may also be associated with various PDU set parameters, such as a PDU set importance parameter (indicating an importance level of the PDU set) or a PDU set integrated handling indication (PSIHI) (indicating whether the PDU set is an all-or-nothing PDU set or a non-all-or-nothing PDU set). For example, a PDU set may be decodable as an all-or-nothing PDU set, where the entire PDU set must be delivered or the PDU set is obsolete, or as a non-all-or-nothing PDU set (such as an application-layer forward error coding (AL-FEC) PDU set, where depending on the redundancy of the AL-FEC, a subset of PDUs of the PDU set can be used to decode the PDU set). PDU sets may be beneficial in applications such as extended reality (XR) in which a unit of information such as a video frame or a slide of a video frame is typically larger than can be conveyed via a single PDU.

As mentioned, a PDU set may be associated with a PDU set importance (PSI) parameter. PDU sets in the same QoS flow can have different PSI parameters. A PSI parameter may generally indicate how important a given PDU set is for an application. For example, in video compression, some frames may be used as a reference for the compression of other frames. A frame used as a reference may have a higher PSI parameter (indicating higher importance) and a frame compressed according to the frame used as a reference may have a lower PSI parameter (indicating lower importance). PSI parameters may be beneficial for prioritizing PDUs or PDU sets to drop in congested conditions.

A UE or a RAN (such as a gNB of the RAN) may discard a PDU according to one or more conditions. For example, a PDU may be discarded if the PDU's delay budget has expired, such as if a packet data convergence protocol (PDCP) discard timer has expired. As another example, a PDU may be discarded if a content criterion of an associated PDU set (to which the PDU belongs) has already been satisfied or can no longer be satisfied, such as if at least one PDU of an all-or-nothing PDU set has been missed or if a sufficient number of PDUs of a non-all-or-nothing PDU set have been received such that the PDU set can be decoded without the PDU.

As mentioned, PSI parameters may be beneficial for prioritizing PDUs or PDU sets to drop in congested conditions. However, it may be unclear what constitutes a congested condition. Without a definition of congestion that is known to the UE and to the RAN, inconsistency may arise in management of PDU sets, such as when to drop or deliver one or more PDUs of a PDU set. Furthermore, it may not be well-defined how a PSI parameter should influence selection of PDUs or PDU sets to be dropped when a congestion condition is identified. Without a definition of congestion that is known to the UE and to the RAN, inconsistency may arise in dropping of PDUs or PDU sets during a congestion condition.

Various aspects of the present disclosure relate generally to delivery of PDU sets. Some aspects more specifically relate to delivery of PDU sets during a congestion condition. In some aspects, a UE may identify a congestion condition. For example, the UE may receive an indication of a congestion condition from a network node. As another example, the UE may identify the congestion condition, such as according to a configured criterion. After identifying the congestion condition, the UE may discard one or more PDUs. For example, the UE may discard the one or more PDUs according to a configured criterion, which may indicate a time threshold for a remaining time associated with the one or more PDUs. As another example, the UE may discard all PDUs associated with a given PSI parameter. As another example, the UE may discard all PDUs associated with PSI parameters that fail to satisfy a threshold.

Various aspects of the present disclosure can be used to realize one or more of the following potential advantages. In some aspects, by receiving the indication of the congestion condition from the network node, the congestion condition can take into account conditions at the network, rather than only conditions detectable at the UE. In some aspects, by identifying the congestion condition at the UE, the UE may conserve processing and signaling resources of the network node, and may reduce overhead of signaling the indication. By discarding one or more PDUs according to the configured criterion, the UE may achieve a common understanding (with the network node) of which PDUs are discarded, thereby improving efficiency of communication. By discarding all PDUs associated with a given PSI parameter, complexity of PDU discarding is reduced. By discarding all PDUs associated with PSI parameters that fail to satisfy a threshold, reliability of PDU sets associated with a high PSI parameter (indicating a greater importance) is improved.

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

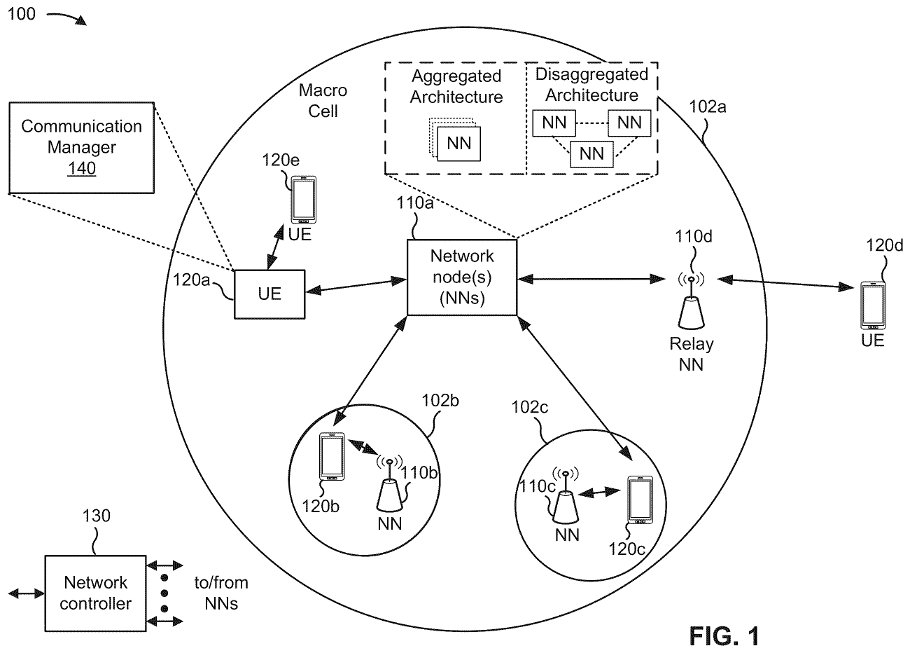

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more network nodes 110 (shown as a network node 110a, a network node 110b, a network node 110c, and a network node 110d), a user equipment (UE) 120 or multiple UEs 120 (shown as a UE 120a, a UE 120b, a UE 120c, a UE 120d, and a UE 120c), and/or other entities. A network node 110 is a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single RAN node (e.g., within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUs)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 may include, for example, an NR base station, an LTE base station, a Node B, an eNB (e.g., in 4G), a gNB (e.g., in 5G), an access point, a transmission reception point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a particular geographic area. In the Third Generation Partnership Project (3GPP), the term “cell” can refer to a coverage area of a network node 110 and/or a network node subsystem serving this coverage area, depending on the context in which the term is used. A network node 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (e.g., a home) and may allow restricted access by UEs 120 having association with the femto cell (e.g., UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (e.g., three) cells. In some examples, a cell may not necessarily be stationary, and the geographic area of the cell may move according to the location of a network node 110 that is mobile (e.g., a mobile network node).

In some aspects, the terms “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the terms “base station” or “network node” may refer to one device configured to perform one or more functions, such as those described herein in connection with the network node 110. In some aspects, the terms “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the terms “base station” or “network node” may refer to any one or more of those different devices. In some aspects, the terms “base station” or “network node” may refer to one or more virtual base stations or one or more virtual base station functions. For example, in some aspects, two or more base station functions may be instantiated on a single device. In some aspects, the terms “base station” or “network node” may refer to one of the base station functions and not another. In this way, a single device may include more than one base station.

The wireless network 100 may include one or more relay stations. A relay station is a network node that can receive a transmission of data from an upstream node (e.g., a network node 110 or a UE 120) and send a transmission of the data to a downstream node (e.g., a UE 120 or a network node 110). A relay station may be a UE 120 that can relay transmissions for other UEs 120. In the example shown in FIG. 1, the network node 110d (e.g., a relay network node) may communicate with the network node 110a (e.g., a macro network node) and the UE 120d in order to facilitate communication between the network node 110a and the UE 120d. A network node 110 that relays communications may be referred to as a relay station, a relay base station, a relay network node, a relay node, a relay, or the like.

The wireless network 100 may be a heterogeneous network that includes network nodes 110 of different types, such as macro network nodes, pico network nodes, femto network nodes, relay network nodes, or the like. These different types of network nodes 110 may have different transmit power levels, different coverage areas, and/or different impacts on interference in the wireless network 100. For example, macro network nodes may have a high transmit power level (e.g., 5 to 40 watts) whereas pico network nodes, femto network nodes, and relay network nodes may have lower transmit power levels (e.g., 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, a UE function of a network node, and/or any other suitable device that is configured to communicate via a wireless or wired medium.

Some UEs 120 may be considered machine-type communication (MTC) or evolved or enhanced machine-type communication (eMTC) UEs. An MTC UE and/or an eMTC UE may include, for example, a robot, an unmanned aerial vehicle, a remote device, a sensor, a meter, a monitor, and/or a location tag, that may communicate with a network node, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120c) may communicate directly using one or more sidelink channels (e.g., without using a network node 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the network node 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHZ) and FR2 (24.25 GHz-52.6 GHZ). It should be understood that although a portion of FR1 is greater than 6 GHZ, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHZ-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHZ), and FR5 (114.25 GHZ-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHZ, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FRI, FR2, FR3, FR4, FR4-a, FR4-1, and/or FR5) may be modified, and techniques described herein are applicable to those modified frequency ranges.

In some aspects, the UE 120 may include a communication manager 140. As described in more detail elsewhere herein, the communication manager 140 may receive a configuration of a criterion for discarding PDUs associated with one or more PDU sets; receive or identify an indication of a congestion condition; and discard one or more PDUs of a PDU set according to a PSI parameter of the PDU set, wherein the discard is based at least in part on the criterion. Additionally, or alternatively, the communication manager 140 may perform one or more other operations described herein.

As indicated above, FIG. 1 is provided as an example. Other examples may differ from what is described with regard to FIG. 1.

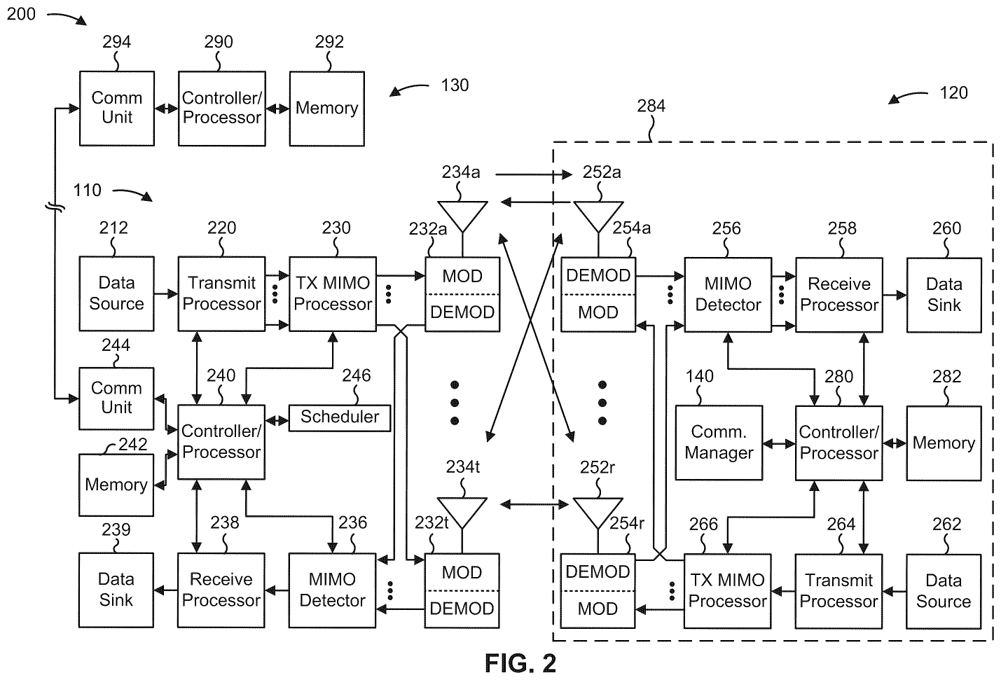

FIG. 2 is a diagram illustrating an example 200 of a network node 110 in communication with a UE 120 in a wireless network 100, in accordance with the present disclosure. The network node 110 may be equipped with a set of antennas 234a through 234t, such as T antennas (T≥1). The UE 120 may be equipped with a set of antennas 252a through 252r, such as R antennas (R≥1). The network node 110 of example 200 includes one or more radio frequency components, such as antennas 234 and a modem 232. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The network node 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the network node 110 and/or other network nodes 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

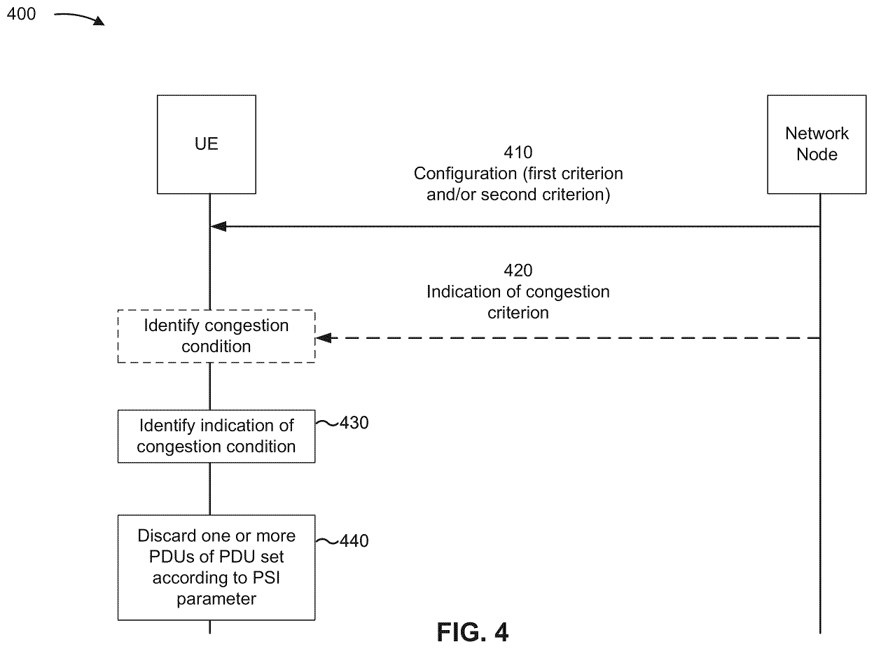

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 4-6).

At the network node 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink and/or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 4-6).

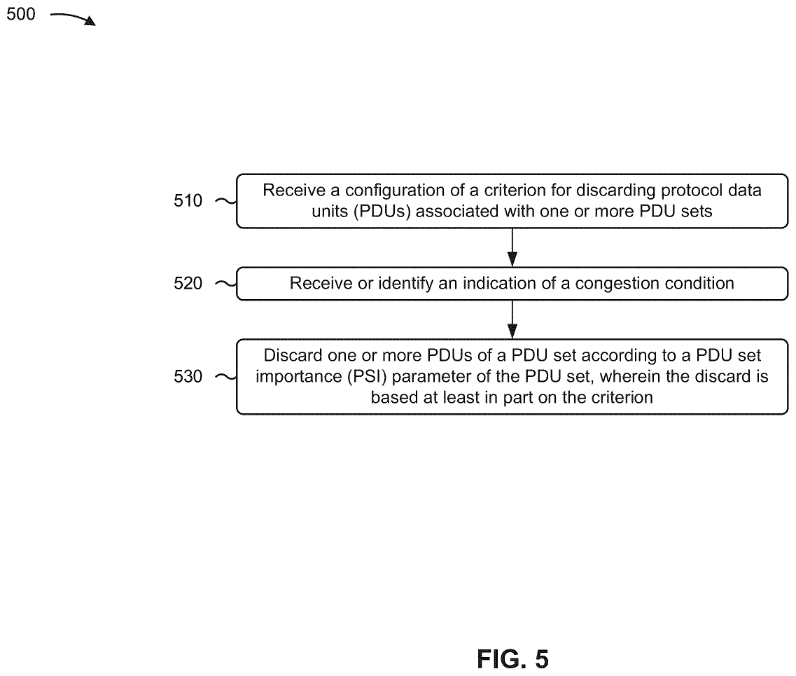

The controller/processor 240 of the network node 110, the controller/processor 280 of the UE 120, and/or any other component(s) of FIG. 2 may perform one or more techniques associated with PDU set transmission, as described in more detail elsewhere herein. For example, the controller/processor 240 of the network node 110, the controller/processor 280 of the UE 120, and/or any other component(s) of FIG. 2 may perform or direct operations of, for example, process 500 of FIG. 5, and/or other processes as described herein. The memory 242 and the memory 282 may store data and program codes for the network node 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the network node 110 and/or the UE 120, may cause the one or more processors, the UE 120, and/or the network node 110 to perform or direct operations of, for example, process 500 of FIG. 5, and/or other processes as described herein. In some examples, executing instructions may include running the instructions, converting the instructions, compiling the instructions, and/or interpreting the instructions, among other examples.

In some aspects, the UE 120 includes means for receiving a configuration of a criterion for discarding PDUs associated with one or more PDU sets; means for receiving or identifying an indication of a congestion condition; and/or means for discarding one or more PDUs of a PDU set according to a PSI parameter of the PDU set, wherein the discard is based at least in part on the criterion. The means for the UE 120 to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, an individual processor may perform all of the functions described as being performed by the one or more processors. In some aspects, one or more processors may collectively perform a set of functions. For example, a first set of (one or more) processors of the one or more processors may perform a first function described as being performed by the one or more processors, and a second set of (one or more) processors of the one or more processors may perform a second function described as being performed by the one or more processors. The first set of processors and the second set of processors may be the same set of processors or may be different sets of processors. Reference to “one or more processors” should be understood to refer to any one or more of the processors described in connection with FIG. 2. Reference to “one or more memories” should be understood to refer to any one or more memories of a corresponding device, such as the memory described in connection with FIG. 2. For example, functions described as being performed by one or more memories can be performed by the same subset of the one or more memories or different subsets of the one or more memories.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR base station, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (e.g., within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU, and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

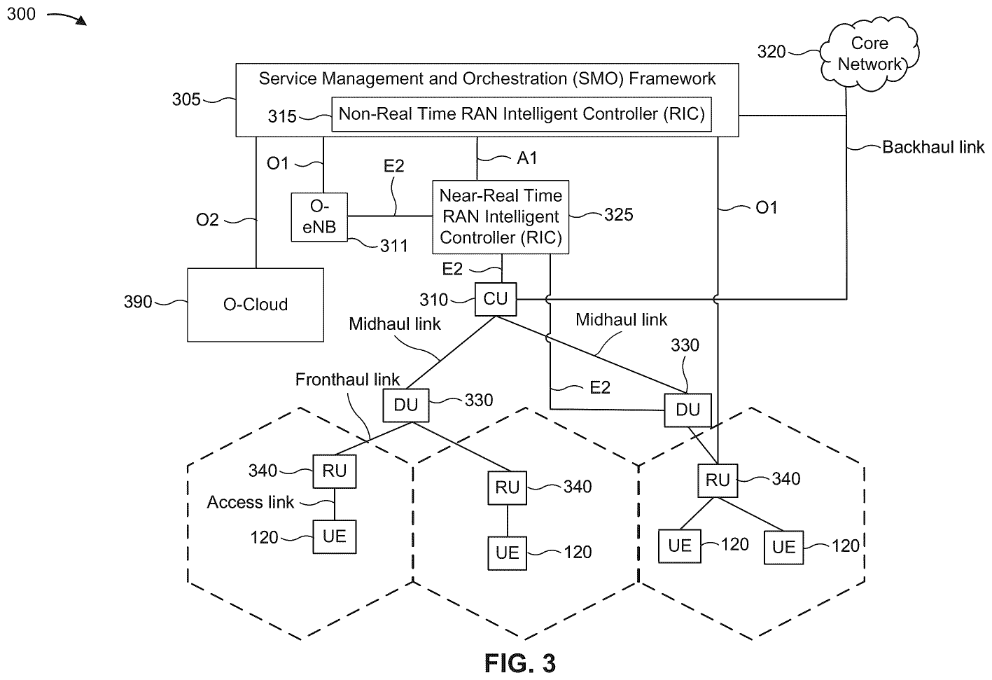

FIG. 3 is a diagram illustrating an example disaggregated base station architecture 300, in accordance with the present disclosure. The disaggregated base station architecture 300 may include a CU 310 that can communicate directly with a core network 320 via a backhaul link, or indirectly with the core network 320 through one or more disaggregated control units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as through F1 interfaces. Each of the DUs 330 may communicate with one or more RUs 340 via respective fronthaul links. Each of the RUs 340 may communicate with one or more UEs 120 via respective radio frequency (RF) access links. In some implementations, a UE 120 may be simultaneously served by multiple RUs 340.

Each of the units, including the CUs 310, the DUs 330, the RUs 340, as well as the Near-RT RICs 325, the Non-RT RICs 315, and the SMO Framework 305, may include one or more interfaces or be coupled with one or more interfaces configured to receive or transmit signals, data, or information (collectively, signals) via a wired or wireless transmission medium. Each of the units, or an associated processor or controller providing instructions to one or multiple communication interfaces of the respective unit, can be configured to communicate with one or more of the other units via the transmission medium. In some examples, each of the units can include a wired interface, configured to receive or transmit signals over a wired transmission medium to one or more of the other units, and a wireless interface, which may include a receiver, a transmitter or transceiver (such as an RF transceiver), configured to receive or transmit signals, or both, over a wireless transmission medium to one or more of the other units.

In some aspects, the CU 310 may host one or more higher layer control functions. Such control functions can include radio resource control (RRC) functions, PDCP functions, or service data adaptation protocol (SDAP) functions, among other examples. Each control function can be implemented with an interface configured to communicate signals with other control functions hosted by the CU 310. The CU 310 may be configured to handle user plane functionality (for example, Central Unit-User Plane (CU-UP) functionality), control plane functionality (for example, Central Unit-Control Plane (CU-CP) functionality), or a combination thereof. In some implementations, the CU 310 can be logically split into one or more CU-UP units and one or more CU-CP units. A CU-UP unit can communicate bidirectionally with a CU-CP unit via an interface, such as the E1 interface when implemented in an O-RAN configuration. The CU 310 can be implemented to communicate with a DU 330, as necessary, for network control and signaling.

Each DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers depending, at least in part, on a functional split, such as a functional split defined by the 3GPP. In some aspects, the one or more high PHY layers may be implemented by one or more modules for forward error correction (FEC) encoding and decoding, scrambling, and modulation and demodulation, among other examples. In some aspects, the DU 330 may further host one or more low PHY layers, such as implemented by one or more modules for a fast Fourier transform (FFT), an inverse FFT (IFFT), digital beamforming, or physical random access channel (PRACH) extraction and filtering, among other examples. Each layer (which also may be referred to as a module) can be implemented with an interface configured to communicate signals with other layers (and modules) hosted by the DU 330, or with the control functions hosted by the CU 310.

Each RU 340 may implement lower-layer functionality. In some deployments, an RU 340, controlled by a DU 330, may correspond to a logical node that hosts RF processing functions or low-PHY layer functions, such as performing an FFT, performing an iFFT, digital beamforming, or PRACH extraction and filtering, among other examples, based on a functional split (for example, a functional split defined by the 3GPP), such as a lower layer functional split. In such an architecture, each RU 340 can be operated to handle over the air (OTA) communication with one or more UEs 120. In some implementations, real-time and non-real-time aspects of control and user plane communication with the RU(s) 340 can be controlled by the corresponding DU 330. In some scenarios, this configuration can enable each DU 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements, which may be managed via an operations and maintenance interface (such as an O1 interface). For virtualized network elements, the SMO Framework 305 may be configured to interact with a cloud computing platform (such as an open cloud (O-Cloud) platform 390) to perform network element life cycle management (such as to instantiate virtualized network elements) via a cloud computing platform interface (such as an O2 interface). Such virtualized network elements can include, but are not limited to, CUs 310, DUs 330, RUs 340, non-RT RICs 315, and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with each of one or more RUs 340 via a respective O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an Al interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via an O1 interface) or via creation of RAN management policies (such as A1 interface policies).

As indicated above, FIG. 3 is provided as an example. Other examples may differ from what is described with regard to FIG. 3.

FIG. 4 is a diagram illustrating an example 400 of signaling associated with discarding PDUs associated with a PSI, in accordance with the present disclosure. Example 400 includes a UE (e.g., UE 120) and a network node (e.g., network node 110).

As shown by reference number 410, the network node may transmit (e.g., using controller/processor 240, transmit processor 220, TX MIMO processor 230, modem 232, antenna 234, and/or the like), and the UE may receive (e.g., using antenna 252, modem 254, MIMO detector 256, receive processor 258, controller/processor 280, reception component 602, and/or the like), a configuration. The configuration may configure a criterion for discarding PDUs associated with one or more PDU sets. In some aspects, this criterion is referred to as a first criterion. In some aspects, the configuration, or other configuration information, may indicate a second criterion for identifying a congestion condition. For example, the network may configure the UE with a congestion criterion, and the UE then evaluates whether the congestion criterion is met. For example, in some aspects, the UE may be configured with a first criterion for discarding PDUs during a congestion condition, and a second criterion for identifying the congestion condition. In some aspects, the UE may be configured with only one of the first criterion or the second criterion. More description of the first criterion and the second criterion is provided in connection with reference numbers 430 and 440, below.

In some aspects, the configuration (or the configuration information) may include semi-static signaling such as RRC signaling. In some aspects, the configuration (or the configuration information) may use a combination of RRC signaling and another form of signaling such as downlink control information (DCI) or MAC signaling that may be used to down-select from multiple RRC-configured configuration options. In some aspects, the configuration (or the configuration information) may be based at least in part on one or more capabilities reported by the UE, such as a capability for identifying a congestion condition and/or a capability for discarding PDUs.

As shown by reference number 420, in some aspects, the network node may transmit (e.g., using controller/processor 240, transmit processor 220, TX MIMO processor 230, modem 232, antenna 234, and/or the like), and the UE may receive (e.g., using antenna 252, modem 254, MIMO detector 256, receive processor 258, controller/processor 280, reception component 602, and/or the like), an indication of a congestion condition. For example, the network may send an indication to UE to activate or deactivate congestion state. For example, the network node may transmit, and the UE may receive, the indication via at least one of an RRC message, a MAC control element (MAC-CE), a PDCP PDU, or an RLC control PDU. In some aspects, the indication may indicate to activate a congestion condition. Thus, the UE may consider the congestion condition to be active after receiving the indication (e.g., until a timer has elapsed, an end to the congestion condition is identified, or the UE receives an indication to deactivate the congestion condition). In some aspects, the network node may deactivate the congestion condition. For example, the network node may transmit, and the UE may receive, an indication to deactivate a congestion condition via at least one of an RRC message, a MAC-CE, a PDCP PDU, or an RLC control PDU.

As shown by reference number 430, in some aspects, the UE may identify (e.g., using antenna 252, modem 254, MIMO detector 256, receive processor 258, controller/processor 280, communication manager 606, and/or the like) the indication of the congestion condition. For example, the UE may identify the indication of the congestion in accordance with a criterion for identifying a congestion condition (e.g., a second criterion, configured in connection with reference number 410). In some aspects, the criterion may be based at least in part on a PDU error rate of one or more data radio bearers (DRBs). For example, the criterion may indicate a threshold PDU error rate. If a PDU error rate (defined, for example, as a percentage of PDUs associated with a receive error or a discard) on a given DRB exceeds the threshold PDU error rate, the UE may identify the congestion condition. For example, the UE may identify the congestion condition if a PDU error rate of a DRB, evaluated over a measurement window, is higher than the threshold PDU error rate by at least X percent (where X is configurable, for example, via the configuration shown by reference number 710), the UE may identify the congestion condition. In some aspects, the threshold PDU error rate may be equal to PSER of the DRB. In some aspects, the DRB may be a DRB, of a plurality of DRBs of the UE, with a highest measured error rate. For example, the congestion criterion may indicate congestion when a PDU error rate of one of the DRBs evaluated over a measurement window is x % higher than a configured threshold (e.g. its PSER). For example, this DRB can be the one with the highest measured error rate

As another example, the criterion (e.g., second criterion) may identify a delay parameter. For example, the criterion may indicate a threshold delay. In some aspects, if an average delay of PDUs (e.g., PDUs of a PDU set, all PDUs) exceeds the threshold delay, the UE may identify a congestion condition. In some aspects, if a threshold percentage (e.g., a Yth percentile, where Y is configurable, for example, via the configuration shown by reference number 410) of PDUs are associated with a delay that exceeds the threshold delay, the UE may identify the congestion condition. For example, the congestion criterion can include an average delay or a y % percentile of PDU experienced delay being higher than a configured threshold.

In some aspects, the UE may identify an end of the congestion condition. For example, the UE may identify an end of the congestion condition upon determining that the criterion (e.g., the second criterion) is no longer satisfied. As another example, the UE may receive an indication from the network node that the congestion condition has ended. As another example, the UE may identify the end of the congestion condition when or in response to an uplink data buffer of the UE being empty (e.g., if UE is already in congestion state, once its UL data buffer becomes empty, it exits congestion state). As another example, the UE may identify the end of the congestion condition according to a timer. For example, the UE may start the timer upon entering the congestion state (such as according to the indication of reference number 420 or the second criterion of reference number 430). The UE may end the congestion state upon expiration of the timer. In some aspects, the UE starts a deactivation timer when it enters congestion state. This timer is stopped when it receives a deactivation indication from the network. When the deactivation timer expires, the UE exits the congestion state.

As shown by reference number 440, the UE may discard (e.g., using controller/processor 280, transmit processor 264, TX MIMO processor 266, modem 254, antenna 252, communication manager 606, transmission component 604, and/or the like) one or more PDUs of a PDU set according to a PSI parameter. For example, the UE may discard the one or more PDUs according to the criterion for discarding PDUs associated with one or more PDU sets. “Discarding one or more PDUs” may include transmitting a communication that omits the one or more PDUs, transmitting a communication unrelated to the one or more PDUs, and/or providing an indication that the one or more PDUs have been dropped. In some aspects described below, the UE may discard the one or more PDUs based at least in part on a PDCP discard timer. In some aspects, the PDCP discard timer may be specific to the congestion state (e.g., the network can configure different sets of PDCP discard timers for the UE to use in a congestion state). For example, the UE may use a first PDCP discard timer when the UE is in a congestion condition, and may use a second PDCP discard timer when the UE is not in a congestion condition.

In some aspects, the UE may discard one or more PDUs according to a criterion (e.g., the first criterion described with regard to reference number 410). For example, the criterion may indicate a time threshold for a remaining time. The remaining time may be based at least in part on a PDCP discard timer and a length of time for which a given PDU has been in a buffer (e.g., an uplink data buffer) of the UE. For example, the remaining time for a given PDU may be defined as (PDCP discard timer minus time spent in buffer). If a PDU arrives in the buffer at slot 0 with a PDCP discard timer of 20 milliseconds, and if each slot is 1 millisecond in length, then the length of the remaining time in slot X is (20 minus X milliseconds). Thus, when the UE is in congestion state, the UE discards PDUs whose remaining time is below a configured threshold.

As mentioned, the criterion may indicate a time threshold for the remaining time. If a given PDU is associated with a remaining time that fails to satisfy (e.g., is lower than) the time threshold, the UE may discard the given PDU. In some aspects, the time threshold may be specific to a PSI parameter (e.g., the network node directly configures different discard thresholds for different PSIs). For example, a first PSI parameter may be configured with a first time threshold and a second PSI parameter may be configured with a second time threshold. Additionally, or alternatively, the time threshold may be based at least in part on a PDCP discard timer. For example, the time threshold may be proportional to the PDCP discard timer. In some aspects, the network node may configure different PSI parameters with different PDCP discard timers (e.g., a PDCP discard timer used to discard one or more PDUs may be specific to a PSI parameter of the one or more PDUs, and/or the network node can configure different durations of PDCP discard timer for different PSIs). Thus, PDUs associated with the PSI parameter may be discarded according to a PDCP discard timer that corresponds to the PSI parameter.

In some aspects, the network node may configure a scaling factor corresponding to a PSI parameter. For example, PSI parameter K may be configured with a scaling factor SF_K (e.g., the network node can additionally configure a scaling factor, SF_k, for PSI level k). PDUs whose remaining time is shorter than (SF_K multiplied by a default PDCP discard timer) may be discarded (e.g., PDUs whose remaining time is shorter than SF x its default PDCP discard timer are discarded).

In some aspects, the UE may discard all PDUs associated with a given PSI parameter (e.g., even PDUs that have long remaining time left). For example, upon entering a congestion state, the UE may discard all PDUs associated with the given PSI parameter. In some aspects, the criterion (e.g., the first criterion) may indicate a threshold for PSI parameters (e.g., the network node can configure which PSIs are subject to discard when UE is in a congestion state). The UE may discard one or more PDUs of a PDU set based at least in part on a PSI parameter of the PDU set failing to satisfy the threshold. For example, the UE may discard all PDUs that have PSI parameters that fail to satisfy the threshold for PSI parameters (e.g., different PSIs are ordered based on their importance, and the network node can configure a threshold level, such that when the UE is in a congestion state, the UE discards PDUs whose PSIs are below the configured threshold level).

As indicated above, FIG. 4 is provided as an example. Other examples may differ from what is described with regard to FIG. 4.

FIG. 5 is a diagram illustrating an example process 500 performed, for example, at a UE or an apparatus of a UE, in accordance with the present disclosure. Example process 500 is an example where the apparatus or the UE (e.g., UE 120) performs operations associated with PDU set discard based on PDU set importance.

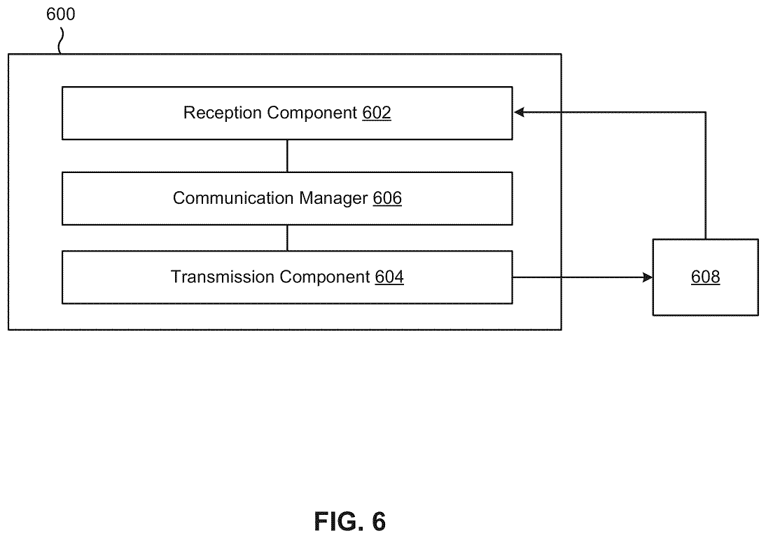

As shown in FIG. 5, in some aspects, process 500 may include receiving a configuration of a criterion for discarding PDUs associated with one or more PDU sets (block 510). For example, the UE (e.g., using reception component 602 and/or communication manager 606, depicted in FIG. 6) may receive a configuration of a criterion for discarding PDUs associated with one or more PDU sets, as described above with regard to reference number 410 of FIG. 4.

As further shown in FIG. 5, in some aspects, process 500 may include receiving or identifying an indication of a congestion condition (block 520). For example, the UE (e.g., using reception component 602 and/or communication manager 606, depicted in FIG. 6) may receive (as described with regard to reference number 420 of FIG. 4) or identify (as described with regard to reference number 430 of FIG. 4) an indication of a congestion condition, as described above. In some cases, process 500 may include only one of block 510 or block 520.

As further shown in FIG. 5, in some aspects, process 500 may include discarding one or more PDUs of a PDU set according to a PSI parameter of the PDU set, wherein the discard is based at least in part on the criterion (block 530). For example, the UE (e.g., using communication manager 606, depicted in FIG. 6) may discard one or more PDUs of a PDU set according to a PSI parameter of the PDU set, wherein the discard is based at least in part on the criterion, as described above with regard to reference number 440 of FIG. 4. In some aspects, the UE may drop all PDUs of the PDU set. In some other aspects, the UE may drop a subset of PDUs of the PDU set, such as according to a PDU set integrated handling indication that indicates whether to drop all or a subset of PDUs of a PDU set.

Process 500 may include additional aspects, such as any single aspect or any combination of aspects described below and/or in connection with one or more other processes described elsewhere herein.

In a first aspect, the criterion indicates a time threshold for a remaining time, wherein the remaining time is based at least in part on a PDCP discard timer and a length of time for which a given PDU has been in a buffer of the UE.

In a second aspect, alone or in combination with the first aspect, the time threshold is specific to the PSI parameter.

In a third aspect, alone or in combination with one or more of the first and second aspects, the time threshold is based at least in part on the PDCP discard timer.

In a fourth aspect, alone or in combination with one or more of the first through third aspects, the PDCP discard timer is specific to the PSI parameter.

In a fifth aspect, alone or in combination with one or more of the first through fourth aspects, a length of the PDCP discard timer is associated with the congestion condition.

In a sixth aspect, alone or in combination with one or more of the first through fifth aspects, the time threshold is based at least in part on combining the PDCP discard timer and a scaling factor, wherein the scaling factor is associated with the PSI parameter.

In a seventh aspect, alone or in combination with one or more of the first through sixth aspects, discarding the one or more PDUs of the PDU set further comprises discarding all PDUs associated with the PSI parameter.

In an eighth aspect, alone or in combination with one or more of the first through seventh aspects, discarding the one or more PDUs of the PDU set further comprises discarding the one or more PDUs based at least in part on the PSI parameter failing to satisfy a threshold.

In a ninth aspect, alone or in combination with one or more of the first through eighth aspects, receiving or identifying the indication of the congestion condition further comprises receiving the indication.

In a tenth aspect, alone or in combination with one or more of the first through ninth aspects, receiving the indication further comprises receiving the indication via at least one of a radio resource control message, a medium access control control element, a PDCP PDU, or a radio link control PDU.

In an eleventh aspect, alone or in combination with one or more of the first through tenth aspects, the criterion is a first criterion and the method further comprises receiving configuration information indicating a second criterion for identifying the congestion condition, wherein receiving or identifying the indication of the congestion condition further comprises identifying the indication in accordance with the second criterion.

In a twelfth aspect, alone or in combination with one or more of the first through eleventh aspects, the second criterion is based at least in part on at least one of a PDU error rate of one or more data radio bearers, or a delay parameter.

In a thirteenth aspect, alone or in combination with one or more of the first through twelfth aspects, process 500 includes ending the congestion condition based at least in part on an uplink data buffer of the UE being empty.

In a fourteenth aspect, alone or in combination with one or more of the first through thirteenth aspects, process 500 includes ending the congestion condition in accordance with a timer.

Although FIG. 5 shows example blocks of process 500, in some aspects, process 500 may include additional blocks, fewer blocks, different blocks, or differently arranged blocks than those depicted in FIG. 5. Additionally, or alternatively, two or more of the blocks of process 500 may be performed in parallel.

FIG. 6 is a diagram of an example apparatus 600 for wireless communication, in accordance with the present disclosure. The apparatus 600 may be a UE, or a UE may include the apparatus 600. In some aspects, the apparatus 600 includes a reception component 602, a transmission component 604, and/or a communication manager 606, which may be in communication with one another (for example, via one or more buses and/or one or more other components). In some aspects, the communication manager 606 is the communication manager 140 described in connection with FIG. 1. As shown, the apparatus 600 may communicate with another apparatus 608, such as a UE or a network node (such as a CU, a DU, an RU, or a base station), using the reception component 602 and the transmission component 604.

In some aspects, the apparatus 600 may be configured to perform one or more operations described herein in connection with FIG. 4. Additionally, or alternatively, the apparatus 600 may be configured to perform one or more processes described herein, such as process 500 of FIG. 5, or a combination thereof. In some aspects, the apparatus 600 and/or one or more components shown in FIG. 6 may include one or more components of the UE described in connection with FIG. 2. Additionally, or alternatively, one or more components shown in FIG. 6 may be implemented within one or more components described in connection with FIG. 2. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 602 may receive communications, such as reference signals, control information, data communications, or a combination thereof, from the apparatus 608. The reception component 602 may provide received communications to one or more other components of the apparatus 600. In some aspects, the reception component 602 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 600. In some aspects, the reception component 602 may include one or more antennas, one or more modems, one or more demodulators, one or more MIMO detectors, one or more receive processors, one or more controllers/processors, one or more memories, or a combination thereof, of the UE described in connection with FIG. 2.

The transmission component 604 may transmit communications, such as reference signals, control information, data communications, or a combination thereof, to the apparatus 608. In some aspects, one or more other components of the apparatus 600 may generate communications and may provide the generated communications to the transmission component 604 for transmission to the apparatus 608. In some aspects, the transmission component 604 may perform signal processing on the generated communications (such as filtering, amplification, modulation, digital-to-analog conversion, multiplexing, interleaving, mapping, or encoding, among other examples), and may transmit the processed signals to the apparatus 608. In some aspects, the transmission component 604 may include one or more antennas, one or more modems, one or more modulators, one or more transmit MIMO processors, one or more transmit processors, one or more controllers/processors, one or more memories, or a combination thereof, of the UE described in connection with FIG. 2. In some aspects, the transmission component 604 may be co-located with the reception component 602 in one or more transceivers.

The communication manager 606 may support operations of the reception component 602 and/or the transmission component 604. For example, the communication manager 606 may receive information associated with configuring reception of communications by the reception component 602 and/or transmission of communications by the transmission component 604. Additionally, or alternatively, the communication manager 606 may generate and/or provide control information to the reception component 602 and/or the transmission component 604 to control reception and/or transmission of communications.

The reception component 602 may receive a configuration of a criterion for discarding PDUs associated with one or more PDU sets. The reception component 602 may receive or identify an indication of a congestion condition. The communication manager 606 may discard one or more PDUs of a PDU set according to a PSI parameter of the PDU set, wherein the discard is based at least in part on the criterion.

The communication manager 606 may end the congestion condition based at least in part on an uplink data buffer of the UE being empty.

The communication manager 606 may end the congestion condition in accordance with a timer.

The number and arrangement of components shown in FIG. 6 are provided as an example. In practice, there may be additional components, fewer components, different components, or differently arranged components than those shown in FIG. 6. Furthermore, two or more components shown in FIG. 6 may be implemented within a single component, or a single component shown in FIG. 6 may be implemented as multiple, distributed components. Additionally, or alternatively, a set of (one or more) components shown in FIG. 6 may perform one or more functions described as being performed by another set of components shown in FIG. 6.

The following provides an overview of some Aspects of the present disclosure:

Aspect 1: A method of wireless communication performed by a user equipment (UE), comprising: receiving a configuration of a criterion for discarding protocol data units (PDUs) associated with one or more PDU sets; receiving or identifying an indication of a congestion condition; and discarding one or more PDUs of a PDU set according to a PDU set importance (PSI) parameter of the PDU set, wherein the discard is based at least in part on the criterion.

Aspect 2: The method of Aspect 1, wherein the criterion indicates a time threshold for a remaining time, wherein the remaining time is based at least in part on a packet data convergence protocol (PDCP) discard timer and a length of time for which a given PDU has been in a buffer of the UE.

Aspect 3: The method of Aspect 2, wherein the time threshold is specific to the PSI parameter.

Aspect 4: The method of Aspect 2, wherein the time threshold is based at least in part on the PDCP discard timer.

Aspect 5: The method of Aspect 2, wherein the PDCP discard timer is specific to the PSI parameter.

Aspect 6: The method of Aspect 2, wherein a length of the PDCP discard timer is associated with the congestion condition.

Aspect 7: The method of Aspect 2, wherein the time threshold is based at least in part on combining the PDCP discard timer and a scaling factor, wherein the scaling factor is associated with the PSI parameter.

Aspect 8: The method of any of Aspects 1-7, wherein discarding the one or more PDUs of the PDU set further comprises discarding all PDUs associated with the PSI parameter.

Aspect 9: The method of any of Aspects 1-8, wherein discarding the one or more PDUs of the PDU set further comprises discarding the one or more PDUs based at least in part on the PSI parameter failing to satisfy a threshold.

Aspect 10: The method of any of Aspects 1-9, wherein receiving or identifying the indication of the congestion condition further comprises receiving the indication.

Aspect 11: The method of Aspect 10, wherein receiving the indication further comprises receiving the indication via at least one of: a radio resource control message, a medium access control control element, a packet data convergence protocol (PDCP) PDU, or a radio link control PDU.

Aspect 12: The method of any of Aspects 1-11, wherein the criterion is a first criterion and the method further comprises: receiving configuration information indicating a second criterion for identifying the congestion condition, wherein receiving or identifying the indication of the congestion condition further comprises identifying the indication in accordance with the second criterion.

Aspect 13: The method of Aspect 12, wherein the second criterion is based at least in part on at least one of: a PDU error rate of one or more data radio bearers, or a delay parameter.

Aspect 14: The method of any of Aspects 1-13, further comprising: ending the congestion condition based at least in part on an uplink data buffer of the UE being empty.

Aspect 15: The method of any of Aspects 1-14, further comprising: ending the congestion condition in accordance with a timer.

Aspect 16: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-15.

Aspect 17: An apparatus for wireless communication at a device, the apparatus comprising one or more memories and one or more processors coupled to the one or more memories, the one or more processors configured to cause the device to perform the method of one or more of Aspects 1-15.

Aspect 18: An apparatus for wireless communication, the apparatus comprising at least one means for performing the method of one or more of Aspects 1-15.

Aspect 19: A non-transitory computer-readable medium storing code for wireless communication, the code comprising instructions executable by one or more processors to perform the method of one or more of Aspects 1-15.

Aspect 20: A non-transitory computer-readable medium storing a set of instructions for wireless communication, the set of instructions comprising one or more instructions that, when executed by one or more processors of a device, cause the device to perform the method of one or more of Aspects 1-15.

Aspect 21: A device for wireless communication, the device comprising a processing system that includes one or more processors and one or more memories coupled with the one or more processors, the processing system configured to cause the device to perform the method of one or more of Aspects 1-15.

Aspect 22: An apparatus for wireless communication at a device, the apparatus comprising one or more memories and one or more processors coupled to the one or more memories, the one or more processors individually or collectively configured to cause the device to perform the method of one or more of Aspects 1-15.

The foregoing disclosure provides illustration and description but is not intended to be exhaustive or to limit the aspects to the precise forms disclosed. Modifications and variations may be made in light of the above disclosure or may be acquired from practice of the aspects.

Further disclosure is included in the appendix. The appendix is provided as an example only and is to be considered part of the specification. A definition, illustration, or other description in the appendix does not supersede or override similar information included in the detailed description or figures. Furthermore, a definition, illustration, or other description in the detailed description or figures does not supersede or override similar information included in the appendix. Furthermore, the appendix is not intended to limit the disclosure of possible aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or any conventional processor, controller, microcontroller, or state machine. A processor also may be implemented as a combination of computing devices, for example, a combination of a DSP and a microprocessor, a plurality of microprocessors, one or more microprocessors in conjunction with a DSP core, or any other such configuration. In some aspects, particular processes and methods may be performed by circuitry that is specific to a given function.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. An apparatus for wireless communication at a user equipment (UE), comprising:
one or more memories; and
one or more processors, coupled to the one or more memories, configured to cause the UE to:
receive a configuration of a criterion for discarding protocol data units (PDUs) associated with one or more PDU sets;
receive or identify an indication of a congestion condition; and
discard one or more PDUs of a PDU set according to a PDU set importance (PSI) parameter of the PDU set, wherein the discard is based at least in part on the criterion.

2. The apparatus of claim 1, wherein the criterion indicates a time threshold for a remaining time, wherein the remaining time is based at least in part on a packet data convergence protocol (PDCP) discard timer and a length of time for which a given PDU has been in a buffer of the UE.

3. The apparatus of claim 2, wherein the time threshold is specific to the PSI parameter.

4. The apparatus of claim 2, wherein the time threshold is based at least in part on the PDCP discard timer.

5. The apparatus of claim 2, wherein the PDCP discard timer is specific to the PSI parameter.

6. The apparatus of claim 2, wherein a length of the PDCP discard timer is associated with the congestion condition.

7. The apparatus of claim 2, wherein the time threshold is based at least in part on combining the PDCP discard timer and a scaling factor, wherein the scaling factor is associated with the PSI parameter.

8. The apparatus of claim 1, wherein the one or more processors, to cause the UE to discard the one or more PDUs of the PDU set, are configured to cause the UE to discard all PDUs associated with the PSI parameter.

9. The apparatus of claim 1, wherein the one or more processors, to cause the UE to discard the one or more PDUs of the PDU set, are configured to cause the UE to discard the one or more PDUs based at least in part on the PSI parameter failing to satisfy a threshold.

10. The apparatus of claim 1, wherein the one or more processors, to cause the UE to receive or identify the indication of the congestion condition, are configured to cause the UE to receive the indication.

11. The apparatus of claim 10, wherein the one or more processors, to cause the UE to receive the indication, are configured to cause the UE to receive the indication via at least one of:
a radio resource control message,
a medium access control control element,
a packet data convergence protocol (PDCP) PDU, or
a radio link control PDU.

12. The apparatus of claim 1, wherein the one or more processors are further configured to cause the UE to:
receive configuration information indicating a second criterion for identifying the congestion condition, wherein receiving or identifying the indication of the congestion condition further comprises identifying the indication in accordance with the second criterion.

13. The apparatus of claim 12, wherein the second criterion is based at least in part on at least one of:
a PDU error rate of one or more data radio bearers, or
a delay parameter.

14. The apparatus of claim 1, wherein the one or more processors are further configured to cause the UE to:
end the congestion condition based at least in part on an uplink data buffer of the UE being empty.

15. The apparatus of claim 1, wherein the one or more processors are further configured to cause the UE to:
end the congestion condition in accordance with a timer.

16. A method of wireless communication performed by a user equipment (UE), comprising:
receiving a configuration of a criterion for discarding protocol data units (PDUs) associated with one or more PDU sets;
receiving or identifying an indication of a congestion condition; and
discarding one or more PDUs of a PDU set according to a PDU set importance (PSI) parameter of the PDU set, wherein the discard is based at least in part on the criterion.

17. The method of claim 16, wherein the criterion indicates a time threshold for a remaining time, wherein the remaining time is based at least in part on a packet data convergence protocol (PDCP) discard timer and a length of time for which a given PDU has been in a buffer of the UE.

18. The method of claim 16, wherein discarding the one or more PDUs of the PDU set further comprises discarding the one or more PDUs based at least in part on the PSI parameter failing to satisfy a threshold.

19. The method of claim 16, wherein receiving or identifying the indication of the congestion condition further comprises receiving the indication via at least one of:
a radio resource control message,
a medium access control control element,
a packet data convergence protocol (PDCP) PDU, or
a radio link control PDU.

20. An apparatus for wireless communication, comprising:
means for receiving a configuration of a criterion for discarding protocol data units (PDUs) associated with one or more PDU sets;
means for receiving or identifying an indication of a congestion condition; and
means for discarding one or more PDUs of a PDU set according to a PDU set importance (PSI) parameter of the PDU set, wherein the discard is based at least in part on the criterion.
